(19) United States
(12) Patent Application Publication
(10) Pub. No.: US 2025/0222985 A1
(43) Pub. Date: Jul. 10, 2025

(54) FRONT STRUCTURE OF VEHICLE BODY

(71) Applicants: Hyundai Motor Company, Seoul (KR); Kia Corporation, Seoul (KR)

(72) Inventors: Jejoon Lee, Hwaseong-si (KR); Dong Kyu Kim, Hwaseong-si (KR); Minjun Cho, Hwaseong-si (KR)

(21) Appl. No.: 18/966,654

(22) Filed: Dec. 3, 2024

(30) Foreign Application Priority Data
Jan. 4, 2024 (KR) 10-2024-0001600

(51) Int. Cl. B62D 25/08

(52) U.S. Cl. CPC B62D 25/08

(57) ABSTRACT

An embodiment front structure of a vehicle body is provided. The front structure includes a chassis frame, a dash panel disposed above the chassis frame, and a sub-fender apron connected to a front portion of the dash panel and including a chassis frame mounting portion to which the chassis frame is mounted.

### CROSS-REFERENCE TO RELATED APPLICATIONS

This application claims the benefit of Korean Patent Application No. 10-2024-0001600, filed on Jan. 4, 2024, which application is hereby incorporated herein by reference.

### TECHNICAL FIELD

The present invention relates to a front structure of a vehicle body.

### BACKGROUND

In the case of a typical monocoque vehicle, the load coming from the chassis module is supported through the fender apron elongated in the length direction of the vehicle body, and the dash panel is placed on top of the fender apron to simply serve as support.

In the case of a vehicle type having a skateboard frame, the dash panel receives the load directly from the mount of the chassis frame, and the fender apron does not extend to the bottom of the dash due to interference with the members of the chassis frame, resulting in insufficient strength at the load input points and insufficient connectivity between the load input points.

The information contained in this background section has been prepared to promote understanding of the background of embodiments of the invention and may include matters that are not already known prior art.

### SUMMARY

The present invention relates to a front structure of a vehicle body. Particular embodiments relate to a front structure of a vehicle body that increases the strength of a load input point transmitted to a dash panel.

Embodiments of the present disclosure provide a front structure of a vehicle body which can enhance the strength of the load input points of the dash panel and secure connectivity between the load input points.

A front structure of a vehicle body according to an exemplary embodiment may include a chassis frame, a dash panel disposed above the chassis frame, and a sub-fender apron connected to a front portion of the dash panel and including a chassis frame mounting portion to which the chassis frame is mounted.

A front structure of a vehicle body according to an exemplary embodiment may further include a fender apron connected to the front portion of the dash panel, and a front end of the sub-fender apron may be connected to the fender apron.

The sub-fender apron may include a front sub-fender apron connected to the fender apron and connected to the dash panel along the length direction of the vehicle body and a rear sub-fender apron connected to a rear portion of the front sub-fender apron and disposed in a width direction outward of the front sub-fender apron.

The sub-fender apron may include a sub-fender apron connecting flange connected to the dash panel and a sub-fender apron body formed to protrude from the sub-fender apron connecting flange.

The sub-fender apron may further include a frame mounting bracket on which the chassis frame is mounted and connected to the rear sub-fender apron.

The sub-fender apron may further include an apron bulk head that is connected to a portion where the front sub-fender apron and the rear sub-fender apron are connected and supports the frame mounting bracket.

The front sub-fender apron may include a front sub-fender apron upper body formed along the length direction of the vehicle body and a front sub-fender apron lower body formed by bending in the width direction of the vehicle body from the front sub-fender apron upper body.

The front structure according to an exemplary embodiment may further include a front side sill extension member connected to the outside of the rear sub-fender apron in the width direction of the vehicle body

The chassis frame may be connected to the front portion of the fender apron.

The front structure according to an exemplary embodiment may further include a dash reinforcement unit connected to the rear portion of the dash panel and including at least one longitudinal member disposed in the length direction of the vehicle body and at least one transverse member disposed in the width direction of the vehicle body.

At least a portion of the front sub-fender apron may overlap with one of the longitudinal members.

At least a portion of the joint between the rear sub-fender apron and the chassis frame may overlap with one of the transverse members.

According to an embodiment of a front structure of a vehicle body, the strength of a load input point of a dash panel can be strengthened and connectivity between the load input points can be secured.

In addition, the effects that can be obtained or expected from embodiments of the present invention are directly or implicitly disclosed in the detailed description of the embodiments of the present invention. That is, various effects predicted according to embodiments of the present invention will be disclosed in the detailed description to be provided later.

### BRIEF DESCRIPTION OF THE DRAWINGS

Since these drawings are for reference in explaining exemplary embodiments of the present invention, the technical ideas of the embodiments of the present invention should not be interpreted as limited to the attached drawings.

FIG. 1 is a side view of a front structure of a vehicle body according to an embodiment.

FIG. 2 is a bottom view of the front structure of a vehicle body according to an embodiment.

FIG. 3 is a perspective view of the front structure of a vehicle body according to an embodiment.

FIG. 4 is a perspective view in one direction of a sub-fender apron that can be applied to the front structure of a vehicle body according to an embodiment.

FIG. 5 to FIG. 7 are partial perspective views from different directions of a sub-fender apron that can be applied to the front structure of a vehicle body according to an embodiment.

FIG. 8 is a perspective view of a dash reinforcement unit that can be applied to the front structure of a vehicle body according to an embodiment.

FIG. 9 is a front view of a dash panel that can be applied to the front structure of a vehicle body according to an embodiment.

FIG. 10 is a cross-sectional view along line X-X of FIG. 2.

FIG. 11 is a cross-sectional view along line XI-XI of FIG. 2.

The following reference identifiers may be used in connection with the drawings to describe various features of embodiments of the present invention.

| | |
|---|---|
| 10: vehicle body | 20: chassis frame |
| 22: chassis frame front connection | 24 chassis frame connecting bolt |
| portion | |
| 30: dash panel | 40: fender apron |
| 50: sub-fender apron | 52: chassis frame mounting portion |
| 60: front sub-fender apron | 62: front sub-fender apron |
| | connecting flange |
| 64: front sub-fender apron body | 66: front sub-fender apron upper |
| | body |
| 68: front sub-fender apron lower | 70: rear sub-fender apron |
| body | |
| 72: rear sub-fender apron connecting | 74: rear sub-fender apron body |
| flange | |
| 76: rear sub-fender apron lower | 80: frame mounting bracket |
| flange | |
| 82: mounting bracket hole | 84: mounting bracket flange |
| 90: apron bulk head | 92: bulk head upper flange |
| 94: bulk head central flange | 96: bulk head lower flange |
| 100: front side sill extension member | 110: dash reinforcement unit |
| 120, 122: longitudinal member | 130, 132, 134: transverse member |

It should be understood that the drawings referenced above are not necessarily drawn to scale, but rather present rather simplified representations of various preferred features illustrating the basic principles of the embodiments of the present invention.

For example, specific design features of the embodiments of the present invention, including particular dimensions, orientations, locations, and shapes, will be determined in part by the particular intended application and usage environment.

### DETAILED DESCRIPTION OF ILLUSTRATIVE EMBODIMENTS

Hereinafter, with reference to the attached drawings, embodiments of the present invention will be described in detail so that a person having ordinary skill in the art to which the present invention pertains can easily practice the present invention.

As those skilled in the art would realize, the described embodiments may be modified in various different ways, all without departing from the spirit or scope of the present invention.

As used herein, the singular forms are intended to include the plural forms as well, unless the context clearly indicates otherwise.

In order to clearly explain the embodiments of the present invention, parts irrelevant to the description are omitted, and the same reference numerals are used for identical or similar components throughout the specification.

The size and thickness of each component shown in the drawings are arbitrarily shown for convenience of explanation, and the embodiments of the present invention are not necessarily limited to what is shown in the drawings. In order to clearly express various parts and areas, the thickness is shown by enlarging it.

In addition, in the detailed description below, the names of the components are divided into first, second, etc. to distinguish them when the components are in a similar relationship, and the description below is not necessarily limited to that order.

Throughout the specification, whenever a part is said to include a certain component, this does not mean that it excludes other components, but rather that it may include other components, unless otherwise specifically stated.

Additionally, terms such as part, portion, means, etc. described in the specification mean comprehensive units of composition that perform at least one function or operation.

When a part, such as a layer, membrane, region, or plate, is referred to as being “over” another part, this includes not only cases where it is directly over the other part, but also cases where there are other parts in between.

In contrast, when an element is referred to as being “directly on” another element, there are no intervening elements present.

In this specification, the term ‘connected’ indicates that a physical relationship exists between two components, for example, in which components are directly connected to each other by welding, self piercing rivet (SPR), flow drill screw (FDS), structural adhesive, or the like, or components that are indirectly connected through one or more intermediate components.

As used herein, ‘vehicle’, ‘vehicular’, ‘automotive’ or other similar terms as used herein generally refer to passenger vehicles, sports cars, sport utility vehicles (SUVs), buses, trucks, and various commercial vehicles including passenger automobiles, hybrid vehicles, electric vehicles, hybrid electric vehicles, electric vehicle-based purpose built vehicles (PBVs), hydrogen-powered vehicles and other alternative fuel vehicles (e.g., other than petroleum fuel derived from resources).

In this specification, the reference direction for explaining the components below may be set as the front-rear direction of the vehicle body (e.g., body length direction or longitudinal direction), the width direction (e.g., lateral direction or left-right direction), and the up-down direction (e.g., height direction or vertical direction) based on the vehicle body.

Furthermore, in this specification, ‘upper end’, ‘upper portion’, or ‘upper surface’ of a component indicates an end, portion, or surface of a component that is relatively upper in the drawing, and ‘lower end’, ‘lower portion’, or ‘lower surface’ of a component indicates an end, portion, or surface of a component that is relatively lower in the drawing.

Furthermore, in this specification, an end of a component (e.g., one end or another (other) end, etc.) denotes an end of a component in any one direction, and an end portion of the component (e.g., one end portion) or other (another) end portion, etc.) denotes a portion of a component that includes that end.

Embodiments will hereinafter be described in detail with reference to the accompanying drawings.

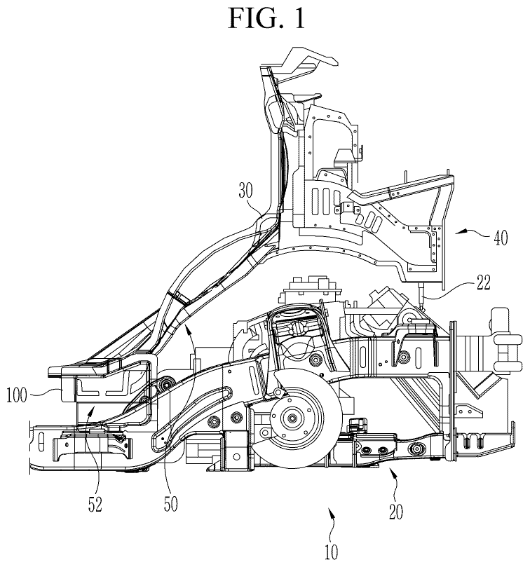

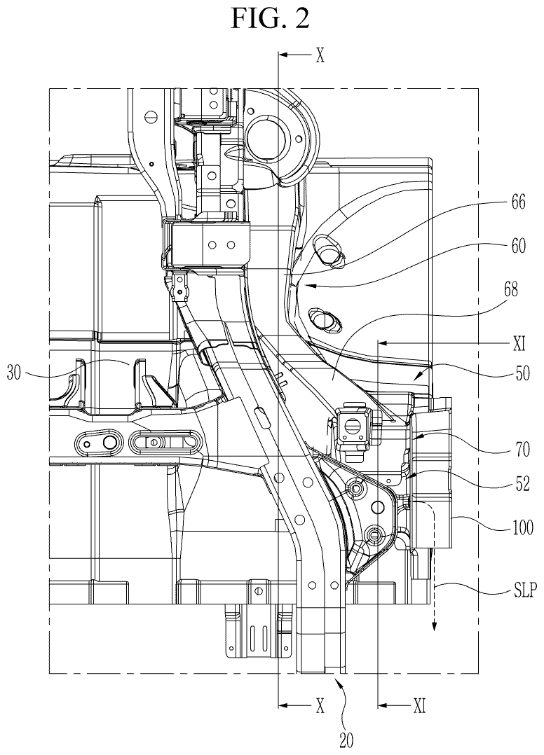

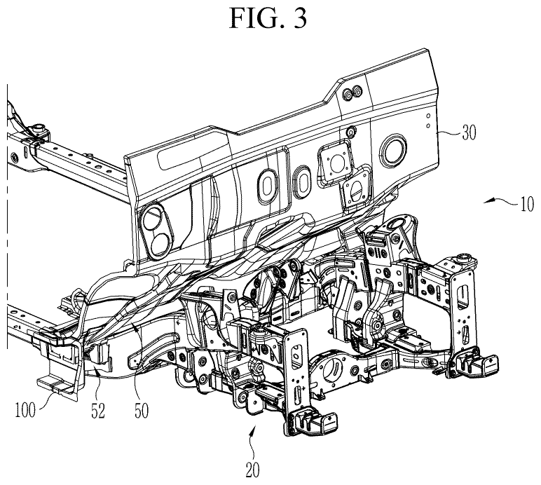

FIG. 1 is a side view of a front structure of a vehicle body according to an embodiment, FIG. 2 is a bottom view of the front structure of a vehicle body according to an embodiment, and FIG. 3 is a perspective view of the front structure of a vehicle body according to an embodiment.

Referring to FIG. 1 to FIG. 3, a front structure of a vehicle body according to an embodiment may include a chassis frame 20, a dash panel 30 disposed above the chassis frame 20, and a sub-fender apron 50 connected to a front portion of the dash panel 30.

In the case of a typical monocoque vehicle, the load coming from the chassis module is supported through the fender apron elongated in the length direction of the vehicle body, and the dash panel is placed on an upper part of the fender apron to simply serve as support.

In the case of the vehicle type having the skateboard frame, the size of the chassis frame is relatively large, and the fender apron does not extend to the bottom of the dash due to interference with the members of the chassis frame, so the dash receives the load directly from the mount part of the chassis frame.

Therefore, the strength of the load input points may be insufficient, and also the connectivity between the load input points may be insufficient.

That is, the space between the chassis frame, which is a type of skateboard frame, and the dash panel is narrow, and the fender apron may not support the lower part of the dash panel due to interference between various parts, so the strength of the connection between the dash panel and the chassis frame may not be adequate.

According to an embodiment, the front structure of a vehicle body has a narrow space between the chassis frame 20 and the dash panel 30, and even if the fender apron 40 cannot extend to the lower part of the dash panel 30 due to interference between various parts, the dash panel 30 may be supported by applying the sub-fender apron 50.

The sub-fender apron 50 includes a chassis frame mounting portion 52 on which the chassis frame 20 is mounted.

The front structure according to an embodiment further includes the fender apron 40 connected to a front portion of the dash panel 30, and a front end of the sub-fender apron 50 may be connected to the fender apron 40.

The chassis frame 20 may be connected to the front portion of the fender apron 40 via a chassis frame front connection portion 22.

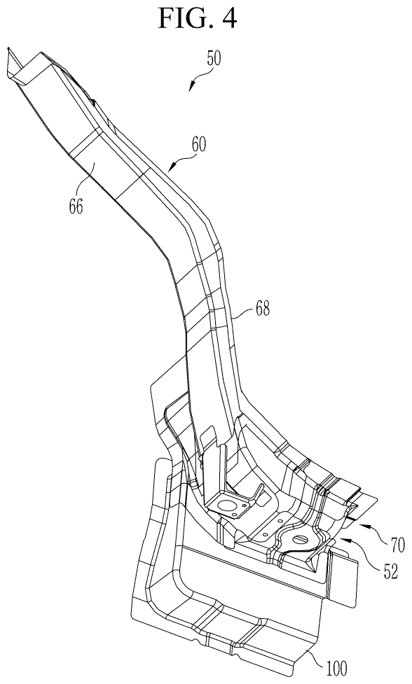

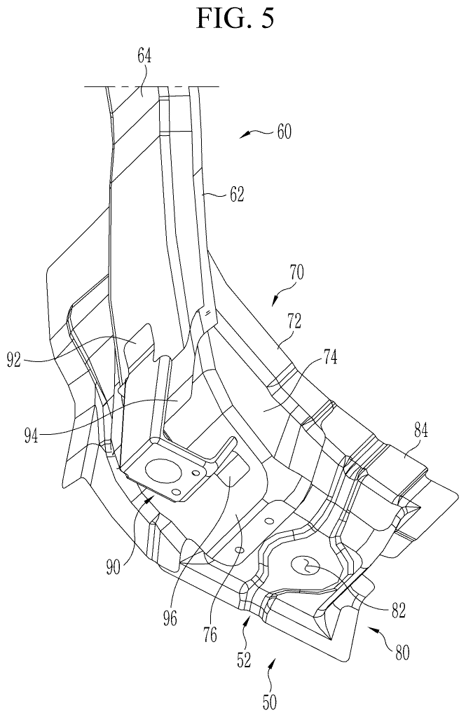

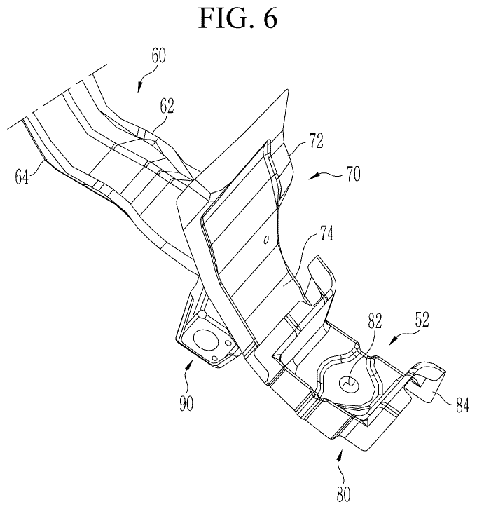

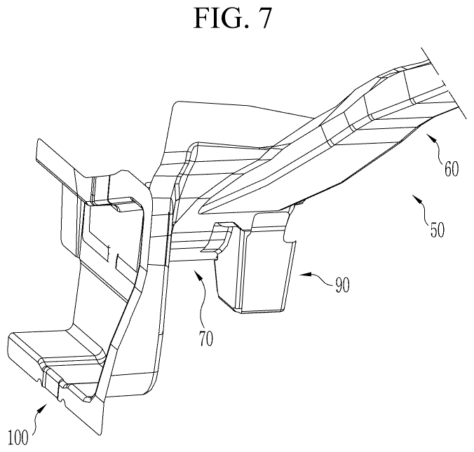

FIG. 4 is a perspective view in one direction of a sub-fender apron that can be applied to the front structure of a vehicle body according to an embodiment, and FIG. 5 to FIG. 7 are partial perspective views from different directions of a sub-fender apron that can be applied to the front structure of a vehicle body according to an embodiment.

Referring to FIG. 1 to FIG. 7, the sub-fender apron 50 may include a front sub-fender apron 60 connected to the fender apron 40 and connected to the dash panel 30 along the length direction of the vehicle body 10 and a rear sub-fender apron 70 connected to a rear portion of the front sub-fender apron 60 and disposed in a width direction outward of the front sub-fender apron 60.

The front structure according to an embodiment may further include a front side sill extension member 100 connected to an outer side of the vehicle body 10 in the width direction of the rear sub-fender apron 70.

In the front structure according to an embodiment, the sub-fender apron 50 is difficult to extend in an interior direction, i.e., inward direction of the vehicle body 10, due to the chassis frame 20.

Accordingly, in the front structure according to an embodiment, the rear sub-fender apron 70 of the sub-fender apron 50 is disposed outside the width direction of the vehicle body 10, and the front side sill extension member 100 is connected outside the width direction of the rear sub-fender apron 70 of the vehicle body 10.

The front side sill extension member 100 is connected to a side sill member (not shown) to disperse the input load SLP transmitted from the chassis frame mounting portion 52.

The sub-fender apron 50 may include a sub-fender apron connecting flange connected to the dash panel 30 and a sub-fender apron body formed protruding from the sub-fender apron connecting flange.

That is, the front sub-fender apron 60 may have increased bonding strength with the dash panel 30 by including a front sub-fender apron connecting flange 62 connected to the dash panel 30.

Additionally, the front sub-fender apron 60 may include a front sub-fender apron body 64 formed to protrude from the front sub-fender apron connecting flange 62, and the strength of the front sub-fender apron 60 may be increased by the protruding shape of the front sub-fender apron body 64.

Additionally, the rear sub-fender apron 70 may include a rear sub-fender apron connecting flange 72 connected to the dash panel 30, thereby increasing the bonding strength with the dash panel 30.

Additionally, the rear sub-fender apron 70 may include a rear sub-fender apron body 74 formed to protrude from the rear sub-fender apron connecting flange 72, and the strength of the rear sub-fender apron 70 may be increased by the protruding shape of the rear sub-fender apron body 74.

The sub-fender apron 50 may further include a frame mounting bracket 80, to which the chassis frame 20 is mounted, connected to the rear sub-fender apron 70.

The rear sub-fender apron 70 may include a rear sub-fender apron lower flange 76 connected to the frame mounting bracket 80.

The frame mounting bracket 80 includes a mounting bracket flange 84 connected to the dash panel 30, and a mounting bracket hole 82 may be formed in the frame mounting bracket 80.

A chassis frame connecting bolt 24 (see FIG. 12) is inserted into the mounting bracket hole 82 so that the frame mounting bracket 80 and the chassis frame 20 may be connected.

The frame mounting bracket 80 may form the chassis frame mounting portion 52.

The sub-fender apron 50 may further include an apron bulk head 90 that is connected to a portion where the front sub-fender apron 60 and the rear sub-fender apron 70 are connected and supports the frame mounting bracket 80.

The apron bulk head 90 may include a bulk head upper flange 92 connected to the front sub-fender apron 60, a bulk head central flange 94 connected to the rear sub-fender apron 70, and a bulk head lower flange 96 connected to the rear sub-fender apron lower flange 76 to support the frame mounting bracket 80.

The front sub-fender apron 60 may include a front sub-fender apron upper body 66 formed along the length direction of the vehicle body 10 and a front sub-fender apron lower body 68 formed by bending in the width direction of the vehicle body 10 from the front sub-fender apron upper body 66.

The front sub-fender apron lower body 68 may be bent outward in the width direction of the vehicle body 10 from the front sub-fender apron upper body 66 to avoid interference with the chassis frame 20.

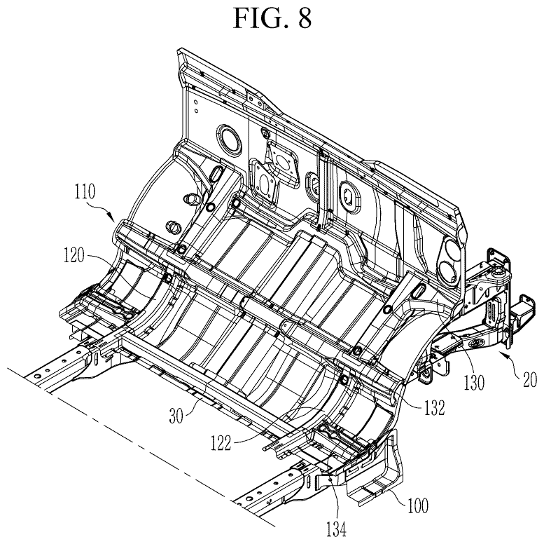

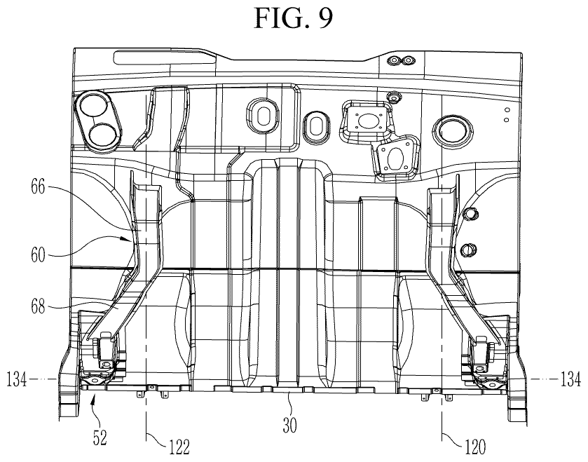

FIG. 8 is a perspective view of a dash reinforcement unit that can be applied to the front structure of a vehicle body according to an embodiment, and FIG. 9 is a front view of a dash panel that can be applied to the front structure of a vehicle body according to an embodiment.

Referring to FIG. 8 and FIG. 9, the front structure of a vehicle body according to an embodiment may further include a dash reinforcement unit 110 connected to a rear portion of the dash panel 30 to support the dash panel 30.

For example, the dash reinforcement unit 110 may include at least one longitudinal member 120 and 122 disposed in the length direction of the vehicle body 10 and at least one transverse member 130, 132, and 134 disposed in the width direction of the vehicle body 10.

The dash reinforcement unit 110 is shown in the drawing as being combined with the dash panel 30 in a lattice shape, but it is not limited thereto and may be configured in various shapes to enhance the strength of the dash panel 30.

At least a portion of the front sub-fender apron 60 may overlap with either of the longitudinal members 120 and 122.

As shown in FIG. 9, the front sub-fender apron upper body 66 of the front sub-fender apron 60 may overlap the position at which the longitudinal members 120 and 122 are mounted.

That is, the single-dot chain line in the vertical direction shown in the drawing represents the joining position of the longitudinal members 120 and 122 mounted on the rear portion of the dash panel 30, and the front sub-fender apron upper body 66 and the longitudinal members 120 and 122 may overlap with the dash panel 30 in between.

At least a portion of the joint between the rear sub-fender apron 70 and the chassis frame 20 may overlap with any one of the transverse members 130, 132, and 134.

That is, the single-dot chain line in the horizontal direction shown in the drawing indicates the joining position of the lower transverse member 134 mounted on the rear portion of the dash panel 30, and the joining portion of the rear sub-fender apron 70 and the chassis frame 20 and the lower transverse member 134 may overlap with the dash panel 30 in between.

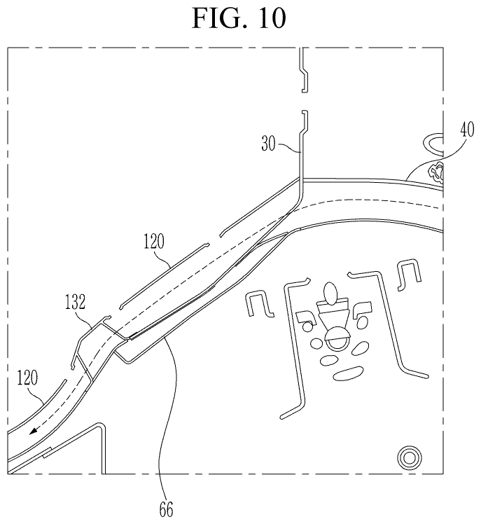

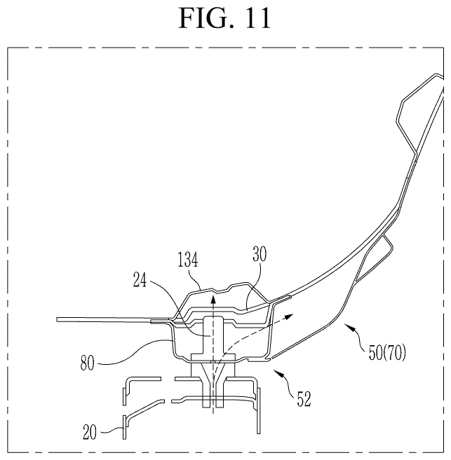

FIG. 10 is a cross-sectional view along the line X-X of FIG. 2, and FIG. 11 is a cross-sectional view along line XI-XI of FIG. 2.

As shown in FIG. 10, the load transferred from the fender apron 40 may be dispersed by the front sub-fender apron upper body 66 of the front sub-fender apron 60 connected to the front portion of the dash panel 30 and the longitudinal member 120 connected to the rear portion of the dash panel 30.

Additionally, as shown in FIG. 11, the load transmitted from the chassis frame 20 may be dispersed by the rear sub-fender apron 70 of the sub-fender apron 50 connected with the dash panel 30 and the transverse member 134.

Referring to FIG. 1, FIG. 2, FIG. 10, and FIG. 11, the fender apron 40 does not extend to the lower portion of the dash panel 30 due to interference with the chassis frame 20, the chassis frame front connection portion 22, where the chassis frame 20 and the fender apron 40 are combined, forms a front load input point, and the chassis frame mounting portion 52, where the chassis frame 20 and the sub-fender apron 50 are combined, forms a rear load input point.

However, the sub-fender apron 50 connects the fender apron 40 and the chassis frame 20, so that the front load input point and the rear load input point are connected.

Therefore, according to an embodiment of the front structure of a vehicle body, the connectivity between load input points can be strengthened, thereby increasing the strength of the vehicle body.

Additionally, according to an embodiment of the front structure of a vehicle body, the front side sill extension member 100 may disperse the load transmitted from the chassis frame mounting portion 52 to the rear of the vehicle body 10 through the side sill.

In addition, according to the front structure of a vehicle body according to an embodiment, the load transmitted from the chassis frame front connecting portion 22 and the chassis frame mounting portion 52 may be dispersed through the dash reinforcement unit 110 connected to the rear portion of the dash panel 30.

According to an embodiment of the front structure of a vehicle body, the strength of a load input point of the dash can be strengthened and connectivity between the load input points can be secured.

While embodiments of this invention have been described in connection with what is presently considered to be practical embodiments, it is to be understood that the embodiments of the present invention are not limited to the disclosed embodiments. On the contrary, they are intended to cover various modifications and equivalent arrangements included within the spirit and scope of the appended claims.

What is claimed is:

1. A front structure of a vehicle body, the front structure comprising:
a chassis frame;
a dash panel disposed above the chassis frame; and
a sub-fender apron connected to a front portion of the dash panel and comprising a chassis frame mounting portion to which the chassis frame is mounted.

2. The front structure of claim 1, further comprising a fender apron connected to the front portion of the dash panel, wherein a front end of the sub-fender apron is connected to the fender apron.

3. The front structure of claim 2, wherein the sub-fender apron comprises:
a front sub-fender apron connected to the fender apron and connected to the dash panel along a length direction of the vehicle body; and
a rear sub-fender apron connected to a rear portion of the front sub-fender apron and disposed in a width direction of the vehicle body outward of the front sub-fender apron.

4. The front structure of claim 3, wherein the sub-fender apron further comprises:
a sub-fender apron connecting flange connected to the dash panel; and
a sub-fender apron body protruding from the sub-fender apron connecting flange.

5. The front structure of claim 3, wherein the sub-fender apron further comprises a frame mounting bracket, on which the chassis frame is mounted, connected to the rear sub-fender apron.

6. The front structure of claim 5, wherein the sub-fender apron further comprises an apron bulk head that is connected to a portion where the front sub-fender apron and the rear sub-fender apron are connected and supports the frame mounting bracket.

7. The front structure of claim 3, wherein the front sub-fender apron comprises:
a front sub-fender apron upper body extending along the length direction of the vehicle body; and
a front sub-fender apron lower body defined by bending in the width direction of the vehicle body from the front sub-fender apron upper body.

8. The front structure of claim 3, further comprising a front side sill extension member connected to an outside of the rear sub-fender apron in the width direction of the vehicle body.

9. The front structure of claim 3, wherein the chassis frame is connected to the front portion of the fender apron.

10. The front structure of claim 3, further comprising a dash reinforcement apparatus connected to a rear portion of the dash panel and comprising a longitudinal member disposed in the length direction of the vehicle body and a transverse member disposed in the width direction of the vehicle body.

11. The front structure of claim 10, wherein a portion of the front sub-fender apron overlaps with the longitudinal member.

12. The front structure of claim 10, wherein a portion of a joint between the rear sub-fender apron and the chassis frame overlaps with the transverse member.

13. A vehicle comprising:
a vehicle body comprising a chassis frame;
a dash panel disposed above the chassis frame;
a fender apron connected to a front portion of the dash panel;
a sub-fender apron connected to the front portion of the dash panel and having a front end connected to the fender apron, the sub-fending apron comprising:
a chassis frame mounting portion to which the chassis frame is mounted:
a front sub-fender apron connected to the fender apron and connected to the dash panel along a length direction of the vehicle body; and
a rear sub-fender apron connected to a rear portion of the front sub-fender apron and disposed in a width direction of the vehicle body outward of the front sub-fender apron; and
a dash reinforcement apparatus connected to a rear portion of the dash panel.

14. The vehicle of claim 13, wherein the sub-fender apron further comprises:
a sub-fender apron connecting flange connected to the dash panel; and
a sub-fender apron body protruding from the sub-fender apron connecting flange.

15. The vehicle of claim 13, wherein the sub-fender apron further comprises a frame mounting bracket, on which the chassis frame is mounted, connected to the rear sub-fender apron.

16. The vehicle of claim 15, wherein the sub-fender apron further comprises an apron bulk head that is connected to a portion where the front sub-fender apron and the rear sub-fender apron are connected and supports the frame mounting bracket.

17. The vehicle of claim 13, wherein the front sub-fender apron comprises:
a front sub-fender apron upper body extending along the length direction of the vehicle body; and
a front sub-fender apron lower body defined by bending in the width direction of the vehicle body from the front sub-fender apron upper body.

18. The vehicle of claim 13, further comprising a front side sill extension member connected to an outside of the rear sub-fender apron in the width direction of the vehicle body.

19. The vehicle of claim 13, wherein the chassis frame is connected to the front portion of the fender apron.

20. The vehicle of claim 13, wherein:
the dash reinforcement apparatus comprises a longitudinal member disposed in the length direction of the vehicle body and a transverse member disposed in the width direction of the vehicle body;
a portion of the front sub-fender apron overlaps with the longitudinal member; and
a portion of a joint between the rear sub-fender apron and the chassis frame overlaps with the transverse member.
